(19) United States
(12) Patent Application Publication
(10) Pub. No.: US 2008/0059071 A1
(43) Pub. Date: Mar. 6, 2008

(54) Meteorological Aerodrome Report to Joint Variable Message Format Formatted Message Conversion System and Method

(76) Inventors: Rimantas T. Meckauskas, Fishers, IN (US); Gregory E. Cerbus, Fairland, IN (US)

Correspondence Address: BAKER BOTTS LLP, 2001 ROSS AVENUE, 6TH FLOOR, DALLAS, TX, 75201-2980, US

(21) Appl. No.: 11/468,904

(22) Filed: Aug. 31, 2006

(51) Int. Cl. G01W 1/00

(52) U.S. Cl. 702/3

(57) ABSTRACT

According to one embodiment of the invention, a method for converting a Meteorological Aerodrome Report (METAR) formatted message to a Joint Variable Message Format (JVMF) formatted message comprises receiving a METAR formatted message and converting the METAR formatted message to a JVMF formatted message. The METAR formatted message and the JVMF formatted messages are both adapted to include weather related information.

### TECHNICAL FIELD OF THE INVENTION

This invention relates to computer systems, and more particularly, to a computer system that is operable to convert Meteorological Aerodrome Report (METAR) formatted messages to Joint Variable Message Format (JVMF) formatted messages and a method of operating the same.

### BACKGROUND OF THE INVENTION

In order to provide weather related information for pilots of aircraft, Meteorological Aerodrome Reports (METARs) have been implemented. These METARs are typically transmitted from a particular airport at least once an hour over various types of transmission mediums, such as the radio frequency (RF) domain or a network such as the Internet. In recent years, the format of the METAR messages has been standardized such that virtually anyone having access to METAR formatted messages may be able to easily decipher information contained in the message. In this manner, pilots and other interested parties may be able to continually monitor the weather conditions of any airport that is configured to transmit such weather related messages.

### SUMMARY OF THE INVENTION

In one embodiment, a method for converting a Meteorological Aerodrome Report (METAR) formatted message to a Joint Variable Message Format (JVMF) formatted message comprises receiving a METAR formatted message and converting the METAR formatted message to a JVMF formatted message. The METAR formatted message and the JVMF formatted messages are both adapted to include weather related information.

In another embodiment, a computer system comprises a memory and a central processing unit coupled to the memory. The central processing unit is operable to receive a METAR formatted message and convert the METAR formatted message to a JVMF formatted message. The METAR formatted message and the JVMF formatted message are both adapted to include weather related information.

Some embodiments of the present invention may provide numerous technical advantages. A technical advantage of one embodiment may include the capability of providing continual weather related information to military personnel or other users of JVMF formatted data.

Although specific advantages have been disclosed hereinabove, it will be understood that various embodiments may include all, some, or none of the disclosed advantages. Additionally, other technical advantages not specifically cited may become apparent to one of ordinary skill in the art following review of the ensuing drawings and their associated detailed description

### BRIEF DESCRIPTION OF THE DRAWINGS

A more complete understanding of embodiments of the invention will be apparent from the detailed description taken in conjunction with the accompanying drawings in which:

FIG. 1 is a diagram of an example computer system upon which one embodiment of the METAR to JVMF formatted message conversion system and method of the present invention may be implemented;

FIG. 2 is an illustration of a METAR formatted message and a resulting JVMF formatted message that may be created by the computing system of FIG. 1;

FIG. 3 is a flow chart depicting a sequence of acts that may be performed in order to implement the METAR to JVMF formatted message conversion program and method of FIG. 1;

FIG. 4 is a table illustrating several METAR data fields that may be used by the computer system of FIG. 1 for placement in the weather conditions JVMF data field;

FIG. 5 is a table illustrating several METAR data fields that may be used by the computer system of FIG. 1 for placement in the relative overcast amount JVMF data field;

FIG. 6 is a table illustrating several METAR data fields that may be used by the computer system of FIG. 1 for placement in the precipitation type JVMF data field;

FIG. 7 is a table illustrating several METAR data fields that may be used by the computer system of FIG. 1 for placement in the precipitation intensity JVMF data field; and

FIG. 8 is a table illustrating one embodiment of a comment JVMF data field having several message fields that may be used by the computer system of FIG. 1.

### DETAILED DESCRIPTION OF EXAMPLE EMBODIMENTS OF THE INVENTION

In the following description, reference is made to the accompanying drawings that illustrate embodiments of the present invention. It is to be understood that other embodiments may be utilized and operational changes may be made without departing from the spirit and scope of the present invention.

Certain embodiments of the present invention may include the capability of providing continual weather related information to military personnel. Because of the constantly changing characteristics of the weather in any given geographical location, the accumulation of this information on a continual basis may be burdensome. Although, the Joint Variable Message Format (JVMF) protocol provides a data structure for inclusion of weather related information, the use of weather related information from one or more METAR formatted messages into the JVMF format has not been established. Thus, certain embodiments may provide a way to access this readily available weather related information for use by military personnel or anyone who needs or desires access to weather related information in JVMF format.

Referring to the drawings, wherein like reference numerals refer to like elements, a computer system 10 is shown upon which a Meteorological Aerodrome Report (METAR) to Joint Variable Message Format (JVMF) formatted message conversion system and method may be implemented according to several embodiments of the present invention.

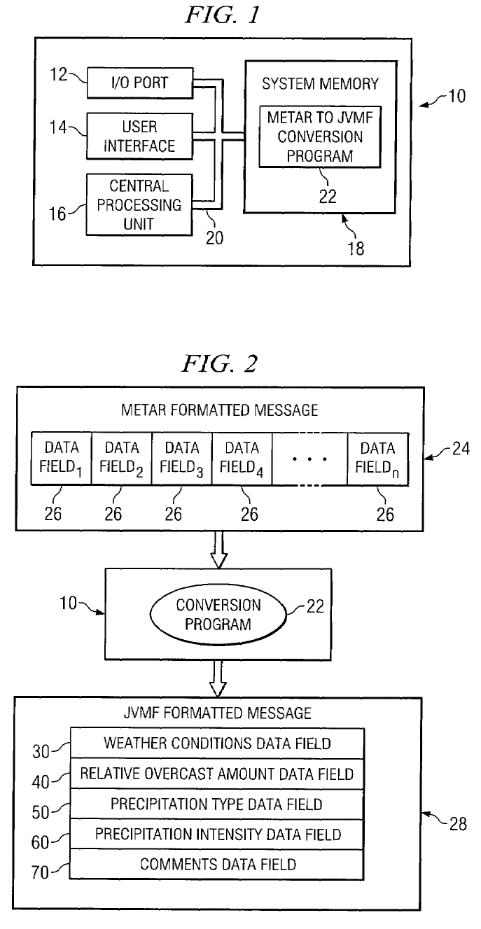

As shown in FIG. 1, an example computer system 10 may include an input/output port 12, a user interface 14, a central processing unit 16, and a memory 18, that are coupled together by a system bus 20.

Input/output port 12 may be configured to receive METAR formatted messages and/or for transmitting JVMF formatted messages to another computer system (not specifically shown). Input/output port 12 may incorporate any suitable protocol, such as, for example, an Ethernet protocol, RS-232 protocol, or other protocol capable of providing communication with other computer equipment. In one embodiment, the input/output port 12 may exist as a single entity whereby all communication to and from the computer system 10 takes place through the input/output port 12. In another embodiment, the input/output port 12 may comprise separate entities such that input to the computer system 10 may be accomplished via one particular protocol and output from the computer system 10 may be accomplished via a differing protocol.

User interface 14 may include a keyboard, mouse, console button, or other similar type user input device for providing a user input signal to the METAR to JVMF formatted message conversion system. Alternatively, the user interface 14 may also include an user output device such as a cathode ray tube (CRT) or liquid crystal display (LCD) for providing visual information to the user. The METAR to JVMF formatted message conversion system as previously described may be any suitable computer system that is capable of converting METAR formatted messages to JVMF formatted messages, which may be, for example, a personal computer, laptop computer, mainframe computer, or any suitable computer system that is adapted for use within a console of a vehicle.

The central processing unit 16 is operable to execute programs or software stored in memory 18. Memory 18 may also be operable to store various forms of data, which may be, for example, information for a user or other forms of data used by the METAR to JVMF formatted message conversion system. The memory 18 may include any volatile or non-volatile memory device, such as read-only memory (ROM), random access memory (RAM), or a fixed storage such as an optical or magnetic bulk data storage medium. In this particular embodiment, the central processing unit 16 may be a conventional microprocessor circuit chip. The system and method of the present invention may utilize a METAR to JVMF conversion program 22 in the form of a set of instructions that are stored in memory 18 and are executable by the central processing unit 16. In general, conversion program 22 may be operable to convert a METAR formatted message into a JVMF formatted message. Additional details of the conversion program 22 will be described below in conjunction with FIGS. 2 through 8.

As shown in FIG. 2, a METAR formatted message 24 may have a number of METAR data fields 26. Each METAR formatted message 24 may be a alpha-numeric string that is terminated by a “=” character. This alpha-numeric string in turn, may have a number of space delimited METAR data fields 26. Each of these METAR data fields 26 may contain one or more aspects of weather related information. The conversion program 22 running on the computer system 10 may be operable to convert weather related information from a METAR formatted message 24 to information in a JVMF formatted message 28.

The JVMF formatted message 28 may be a particular type of JVMF formatted message that may include weather related information, such as a K04.13 type JVMF formatted message. Accordingly, the JVMF K04.13 formatted message may have a number of JVMF data fields, wherein each JVMF data field may have values related to one or more aspects of weather related information. Several example JVMF data fields may be a weather conditions data field 30 that may provide an overall summary indication of weather conditions. The relative overcast amount JVMF data field 40 may provide overcast weather information regarding the cloudiness of a particular region. The precipitation type JVMF data field 50 may indicate the variety of moisture within a particular region. The precipitation intensity JVMF data field 60 may indicate the intensity of the precipitation type indicated in the precipitation type JVMF data field 50. The comments JVMF data field 70 may provide a free form textual bytes of information to be included in the JVMF formatted message 28. The above described JVMF data fields provide several aspects of weather related information that may be accessed by users of the system 10. It should be appreciated that the previously described JVMF data fields do not comprise an exhaustive list of all available JVMF data fields, however only several key JVMF data fields are described herein for the purposes of brevity and clarity of disclosure.

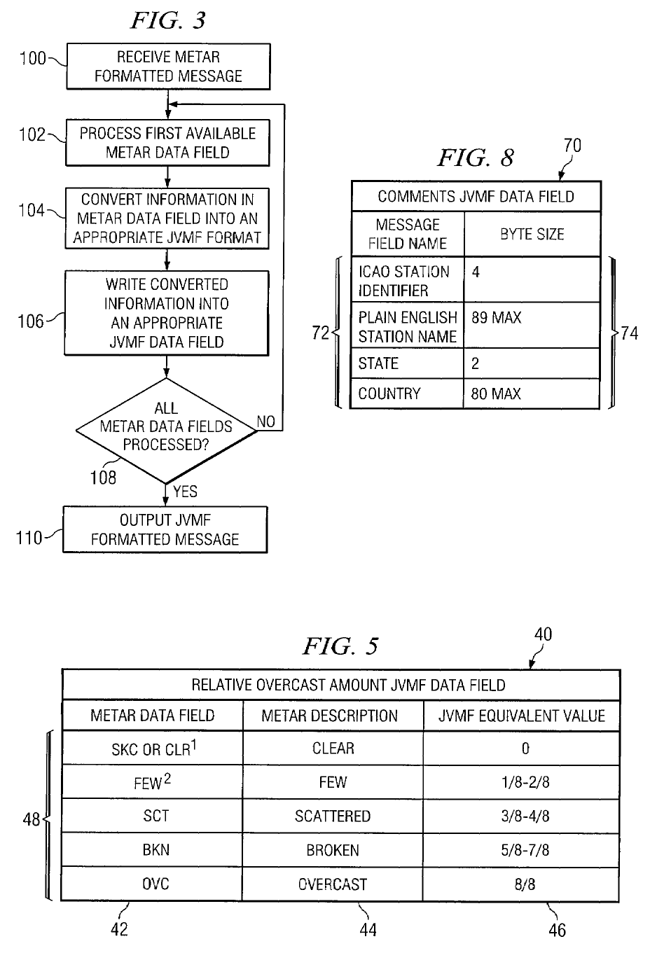

Conversion program 22 may form a sequence of acts that are used to implement one embodiment of a conversion method as shown in FIG. 3. In act 100, the conversion program 22 may receive a METAR formatted message 24 from either the input/output port 12 or from memory 18. For example, the conversion program 22 may receive the METAR formatted message 24 from a radio device that is coupled to the computer system 10 via the input/output port 12. The conversion program 22 may also receive the METAR formatted message 24 from its own memory 18. Thus, in this particular instance, the conversion program 22 may be operable to initially receive the METAR formatted message 24 from input/output port 12 and subsequently store the METAR formatted message 24 in memory 18 for later conversion by the conversion program 22. In act 102, the conversion program 22 may read the next available METAR data field 26 from the METAR formatted message 24. To accomplish this, the conversion program 22 may parse the METAR formatted message 24 into a number of METAR data fields 26 and place each in a que for processing. Next in act 104, the conversion program 22 may determine the type of METAR data field 26 and convert any information contained therein into a type in accordance with the JVMF format. In act 106, the conversion program 22 may write this converted information into its appropriate JVMF data field. The conversion program 22 may perform acts 100 through 106 repeatedly until all METAR data fields 26 of the METAR formatted message 24 have been processed, act 108. After all METAR data fields 26 have been processed, the conversion program 22 will then output the JVMF formatted message 28.

Acts 102 through 108 describes one embodiment of a sequence of acts that may be used to convert the METAR formatted message to the JVMF formatted message. In one embodiment, the conversion program 22 may be operable to convert the METAR formatted message 24 to the JVMF formatted message 28 automatically upon receipt of the METAR formatted message 24. In this particular embodiment, receipt of the METAR formatted message 24 from the input/output port 12 may serve to automatically initiate the conversion process. That is, the conversion program 22 may be responsive to receipt of the METAR formatted message 24 in order to automatically initiate the conversion process. In another embodiment, the conversion program 22 may be responsive to a user input signal from a user input device in order to initiate the conversion process. For example, the user may select a particular METAR formatted message 24 that is stored in memory 18 using the user interface 16. Upon receipt of a particular user input signal from the keyboard, the system may then initiate a conversion of the METAR formatted message 24 to the JVMF formatted message 28.

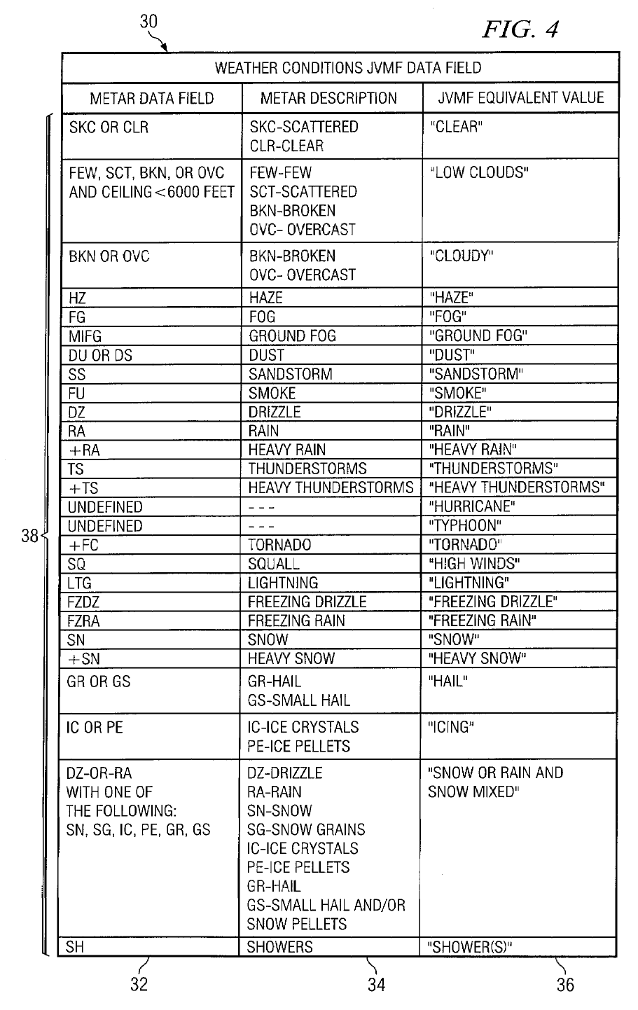

FIG. 4 depicts a table 30 of one embodiment that may be used for conversion of several METAR data fields to a weather conditions JVMF data field. Table 30 has a METAR data field column 32, a METAR description column 34, and a JVMF equivalent value column 36. The METAR data field column 32 has a number of METAR data fields that may be converted to JVMF equivalent values. The table 30 has a number of rows 38 each having at least one possible value for a METAR data field. As shown, each METAR data field generally comprises an abbreviated alpha-numeric textual string that is two to four bytes in size. A METAR description 34 is also shown that provides a long form description of its abbreviated METAR data field 32.

If a particular METAR data field is found in the METAR formatted message during conversion, the conversion program 22 may place a numeric value corresponding to an equivalent alpha-numeric JVMF textual value in the weather condition JVMF data field. For example, in the event that the METAR formatted message contains a “HZ”, “FG”, “MIFG”, “SS”, “FU”, “DZ”, “RA”, “+RA”, “TS”, “+TS”, “+FC”, “SQ”, “LTG”, “FZDZ”, “FZRA”, “SN”, “+SN”, or “SH” METAR data field, the conversion program 22 may place a numeric value associated with the “haze”, “fog”, “ground fog”, “sandstorm”, “smoke”, “drizzle”, “rain”, “heavy rain”, “thunderstorm”, “heavy thunderstorm”, “tornado”, “squall”, “lightning”, “freezing drizzle”, “freezing rain”, “snow”, “heavy snow”, or “showers” textual value respectively in the weather condition JVMF data field.

If the conversion program 22 detects the presence of a “SKC” or “CLR” METAR data field, a numeric value associated with the “clear” textual value will be placed in the weather condition JVMF data field. If the conversion program 22 detects the presence of a “FEW”, “SCT”, “BKN”, or “OVC” METAR data field and the reported ceiling is less than 6000 feet, a numeric value representing a “low clouds” textual value will be placed in the weather condition JVMF data field. If the conversion program 22 detects the presence of a “BKN” or “OVC” METAR data field, a numeric value associated with the “cloudy” textual value will be placed in the weather condition JVMF data field. If the conversion program 22 detects the presence of a “GR” or “GS” METAR data field, a numeric value associated with the “hail” textual value will be placed in the weather condition JVMF data field. If the conversion program 22 detects the presence of a “IC” or “PL” METAR data field, a numeric value associated with the “icing” textual value will be placed in the weather condition JVMF data field. If the conversion program 22 detects the presence of a “DZ” or “RA” METAR data field and either of a “SN”, “SG”, “IC”, “PL”, “GR”, or “GS” METAR data field, a numeric value associated with the “snow or rain and snow mixed” textual value will be placed in the weather condition JVMF data field.

FIG. 5 shows a table 40 of one embodiment that may be used for conversion of particular METAR data fields to a relative overcast amount JVMF data field. The table 40 has a METAR data field column 42, a METAR description column 44, and a JVMF equivalent value column 46. The METAR data field column 42 has a number of METAR data fields that may be converted to JVMF equivalent values for the relative overcast amount JVMF data field. The table 40 has a number of rows 48 each having at least one possible value for a METAR data field. A METAR description is also shown that provides a long form description of the abbreviated METAR data field.

If particular METAR data fields are found in the METAR formatted message during conversion, the conversion program 22 may place a numeric value corresponding to its JVMF equivalent value in the relative overcast amount JVMF data field. For example, METAR data fields such as the “SKC”, “CLR”, “FEW”, “SCT”, “BKN”, or “OVC” alpha-numeric characters may be used to indicate the relative overcast amount. Conversely, the JVMF equivalent values for these METAR data fields may be numeric values representing fractional values that ascend from 0 (“CLR”) to 8/8 (“OVC”) in increments of one-eighths. Thus, when the conversion program 22 detects the presence of either of the aforementioned METAR data fields, a numeric value corresponding to its JVMF equivalent value may be placed in the relative overcast amount JVMF data field.

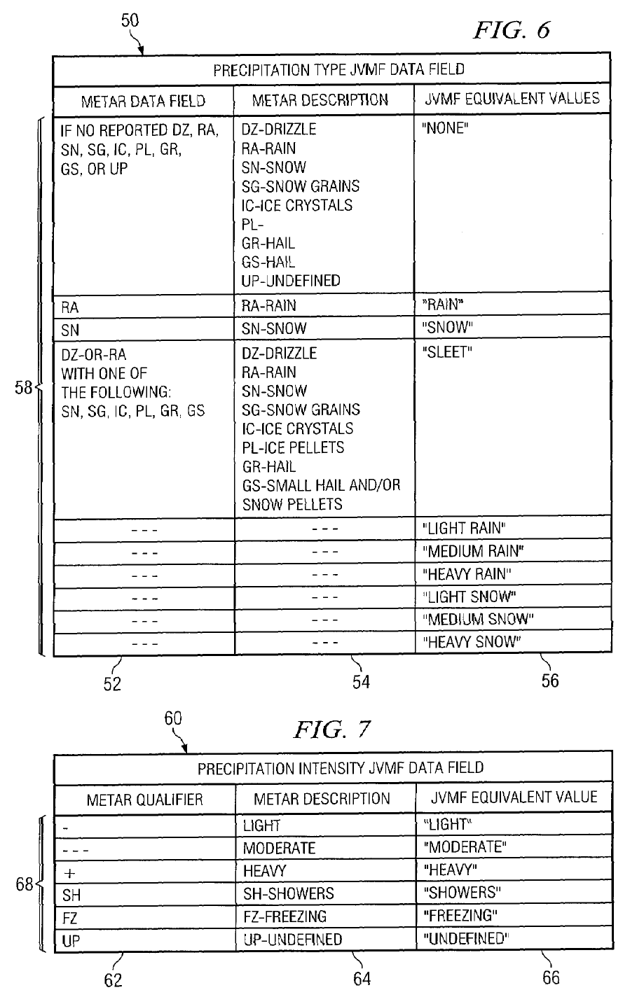

FIG. 6 shows a table 50 depicting several METAR data fields of one embodiment that may be converted into corresponding values for the precipitation type JVMF data field. The table 50 has a METAR data field column 52, a METAR description column 54, and a JVMF equivalent value column 56. The table 50 has a number of rows 58 each having at least one possible value for a METAR data field.

If the conversion program 22 detects the presence of a “DZ” or “RA” METAR data field and either of a “SN”, “SG”, “IC”, “PL”, “GR”, or “GS” METAR data field, a numeric value associated with the “sleet” textual value may be placed in the precipitation type JVMF data field. If the system detects the presence of a “RA”, or “SN” METAR data field, a numeric value associated with the “rain”, or “snow” textual value respectively may be placed in the precipitation type JVMF data field. However, if the METAR formatted message contains none of the aforementioned precipitation type METAR data fields, a numeric value representing the “none” textual value may be placed in the JVMF data field. Shown also in FIG. 6 are the “light rain”, “medium rain”, “heavy rain”, “light snow”, “medium snow”, and “heavy snow” values for the precipitation type JVMF data field. These values are redundant in the JVMF data field and therefore will not be used in one example of the conversion process of the present invention.

FIG. 7 is a table 60 showing several METAR qualifiers of one embodiment that may be mapped into corresponding values for the precipitation intensity JVMF data field. Table 60 has a METAR qualifier column 62, a METAR description column 64, and a JVMF equivalent value column 66. Table 60 also has a number of rows 68 for each possible JVMF equivalent value 66. Each METAR qualifier 68 may exist as a prefix to an associated METAR precipitation type 52 and serves to indicate the intensity of the precipitation. For example, METAR data fields such as “−RA”, “RA”, and “+RA” may indicate the presence of rain having a light, moderate, and heavy intensities respectively. Thus, during the conversion process, if the conversion program 22 detects the presence of a “−”, “ ”, “+”, “SH”, “FZ”, or “UP” prefixes appended to a particular instance of the precipitation type METAR data field 52, a numeric value associated with the “light”, “moderate”, “heavy”, “showers”, “freezing”, or “undefined” textual values respectively may be placed in the precipitation intensity JVMF data field. It is important to note that the absence of a METAR qualifier signifies a “moderate” intensity of its associated precipitation type 52.

FIG. 8 is a table 70 depicting one embodiment of a comments JVMF data field of one embodiment according to the present invention. According to the JVMF protocol, the comments JVMF data field has a maximum byte count of 175 characters. Given this constraint, the comments JVMF data field may include any suitable string of alpha-numeric characters whose quantity is equal to or less than 175 characters.

In one embodiment, the comments JVMF data field may include several message fields 72 that are delimited by one or more alpha-numeric characters. In the particular embodiment shown in FIG. 8, four message fields 72 are included in the comments JVMF data field and are each delimited by a semicolon character. Associated with each message field is a maximum byte count 74 that each message field may have. One message field, namely the International Civil Aviation Organization (ICAO) station identifier is a four digit alpha-numeric code that is assigned to each airport. Thus, the ICAO station identifier is a way to determine the location of the particular airport. The latitude/longitude coordinates of the ICAO station identifier is stored in a separate part of the JVMF message other than the comments JVMF data field. An ICAO station identifier lookup table may be stored in memory 18 and accessed each time a conversion of a METAR formatted message to a JVMF formatted message is performed. The ICAO station identifier lookup table may include other useful information about the particular airport such as a plain English station name, as well as the state, and country where the airport is located.

The plain English station name may be a long form string of textual characters indicating the name of the particular airport in plain English. For example, if the conversion program 22 detects the presence of ICAO station identifier METAR data field having the alpha-numeric string “KDFW”, the lookup table may return the value “Dallas-FtWorth” for the plain English station name message, “Texas” for the state message field, and “United States” for the country message field. These values may then be placed in the comments JVMF data field with a semicolon in between each message field. In another embodiment, if the ICAO station identifier METAR data field indicates an airport that is located outside of the United States, then the state message field may contain an empty string.

In addition to the previously described JVMF data fields, the conversion program 22 may also be operable to convert other JVMF data fields from the METAR formatted message. In one embodiment, the conversion program 22 may be capable of resolving the longitude and latitude coordinates from the ICAO station identifier METAR data field. In another embodiment, the longitude and latitude coordinates associated with each airport may be stored in the ICAO station identifier lookup table. Thus, the conversion program 22 may obtain longitude and latitude coordinate data for any particular airport by accessing that particular airport information from the ICAO station identifier lookup table.

The conversion program 22 may also be capable of resolving a minimum ceiling JVMF data field from the METAR formatted message. The METAR formatted message may include a “BKN” or an “OVC” METAR data field that indicates a particular level of cloudiness. Associated with each “BKN” or “OVC” METAR data field may be a numeric value indicating the height of the cloud cover above ground level. In one embodiment, the conversion program 22 may access this numeric value for placement into the minimum ceiling JVMF data field. For example, the METAR formatted message may include a METAR data field having a value of “BKN045”. This particular instance indicates that broken cloud cover exists at 4500 feet elevation above ground level. Thus, the conversion program 22 may be operable to place a numeric value of “4500” in the minimum ceiling JVMF data field.

Both the METAR formatted message and the JVMF formatted message have data fields that provide visibility information. However, the JVMF data field has a maximum reporting range of 7.767 miles, a distance that is shorter than the maximum reporting range of its METAR data field counterpart. In one embodiment, the conversion program 22 may be operable to place the maximum value of 7.767 miles into the visibility JVMF data field in the event that the visibility METAR data field is greater than 7.767 miles.

In another embodiment, an additional message field may be utilized as a portion of the comments JVMF data field described above. For example, the comments JVMF data field as shown in FIG. 8 may be modified to have five message fields that are each delimited by a semicolon character, namely an ICAO station identifier, a plain English station name, a state, a country, and a visibility message field. In order to accommodate the 175 character maximum limit, the maximum byte size of the country message field may be shortened to 74 characters in order to provide six bytes for the visibility message field. The previous example describes a visibility message field that has been incorporated into the comments field, however, it may be appreciated that the conversion program 22 of the present invention may utilize the comments JVMF data field to store virtually any weather related data from a particular METAR data field that is not easily converted to a corresponding JVMF data field.

In another embodiment, the conversion program 22 may be operable to convert a barometric pressure and an altimeter setting METAR data field to a corresponding barometric pressure and an altimeter setting JVMF data field respectively. Within the METAR message protocol, the barometric pressure METAR data field is reported in the remarks section of the METAR formatted message. The remarks section of the METAR formatted message however, is a convention that has only been adopted within the United States. Moreover the remarks section of the METAR formatted message may not exist in METAR formatted messages from airports located in foreign countries. As a result, this information may not always be available with every METAR formatted message.

To handle this situation, the conversion program 22 may be operable to place an illegal value in the barometric pressure JVMF data field in the event that this information is not available within the METAR formatted message. For example, the conversion program 22 may receive a METAR formatted message having no remarks section. In this particular instance, the METAR formatted message would have no barometric pressure METAR data field. In response, the conversion program 22 may place an illegal value in the barometric pressure JVMF data field. In one embodiment, the illegal value may be a numeric value outside the range of allowable values for its respective field. Thus, if the allowable range of values for the barometric pressure JVMF data field has a maximum value of 32, a numeric value greater than 32 would be placed in the barometric pressure JVMF data field. In another embodiment, a numeric value of 32.01 may be placed in the barometric pressure JVMF data field.

The foregoing example described one approach for converting barometric pressure information when the barometric pressure METAR data field does not exist. However, the conversion program 22 may be operable to place an illegal value in virtually any JVMF data field in order to indicate the absence of corresponding data from the METAR formatted message. For example, if the METAR formatted message does not have a altimeter setting METAR data field, the conversion program 22 may respond by placing an illegal value in the altimeter setting JVMF data field. Since the maximum allowable numeric value for the altimeter setting JVMF data field is 31, a numeric value of 31.01 may be placed in the altimeter setting JVMF data field in the event that no altimeter setting METAR data field exists in the METAR formatted message.

It will be apparent that many modifications and variations may be made to embodiments of the present invention, as set forth above, without departing substantially from the principles of the present invention. For example, the conversion program 22 may be operable to convert particular METAR data fields to other JVMF data fields than described above. The foregoing description has merely described only several of all possible JVMF data fields for the purposes of brevity and clarity of disclosure. Therefore, all such modifications and variations are intended to be included herein within the scope of the present invention, as defined in the claims that follow.

1. A computer-implemented method comprising:
receiving a Meteorological Aerodrome Report (METAR) formatted message, the METAR formatted message having a plurality of METAR data fields for the storage of weather related information;
converting the METAR formatted message to a JVMF formatted message, the Joint Variable Message Format (JVMF) formatted message having a plurality of JVMF data fields;
placing latitude and longitude coordinates in a corresponding latitude and longitude JVMF data fields respectively, the latitude and longitude coordinates being derived from a particular METAR data field including an International Civil Aviation Organization (ICAO) station identifier;
placing the ICAO station identifier in a comment field of the JVMF formatted message;
determining that a first particular METAR data field does not include a corresponding JVMF data field of the same type and in response storing the first particular METAR data field in the comment field of the JVMF formatted message; and
determining that a second particular METAR data field is temporarily unavailable and in response placing an illegal value in a corresponding JVMF data field.

2. The computer-implemented method of claim 1, wherein the first particular METAR data field is a visibility METAR data field.

3. The computer-implemented method system of claim 1, wherein the second particular METAR data field is an altimeter setting METAR data field.

4. The computer-implemented method of claim 1, wherein placing the latitude and longitude coordinates in a corresponding latitude and longitude JVMF data fields respectively is accomplished via a lookup table.

5. The computer-implemented method of claim 1, wherein a particular one of the JVMF data fields is a comments JVMF data field, the comments JVMF data field comprises a plurality of message fields, at least one of the plurality of message fields being a plain English station name.

6. A computer-implemented method comprising:
receiving a Meteorological Aerodrome Report (METAR) formatted message; and
converting the METAR formatted message to a JVMF formatted message, the METAR formatted message and the Joint Variable Message Format (JVMF) formatted messages being adapted to include weather related information.

7. The computer-implemented method of claim 6, and further comprising automatically initiating conversion of the METAR formatted message in response to receiving the METAR formatted message

8. The computer-implemented method of claim 6, and further comprising storing the METAR formatted message in a memory and initiating conversion of the METAR formatted message in response to a manual input signal from a user.

9. The computer-implemented method of claim 6, and further comprising placing latitude and longitude coordinates in a corresponding latitude and longitude JVMF data fields respectively, the latitude and longitude coordinates being derived from an International Civil Aviation Organization (ICAO) station identifier.

10. The computer-implemented method of claim 6, and further comprising placing the ICAO station identifier in a comments field of the JVMF formatted message.

11. The computer-implemented method of claim 6, and further comprising determining that a particular METAR data field does not include a corresponding JVMF data field of the same type and in response storing the particular METAR data field in a comment field of the JVMF formatted message.

12. The computer-implemented method of claim 6, and further comprising determining that a particular METAR data field is temporarily unavailable and in response placing an illegal value in a corresponding JVMF data field.

13. A computer system comprising:
a memory; and
a central processing unit coupled to the memory, the central processing unit being operable to
receive a Meteorological Aerodrome Report (METAR) formatted message, and
convert the METAR formatted message to a Joint Variable Message Format (JVMF) formatted message, the METAR formatted message and the JVMF formatted message being adapted to include weather related information.

14. The computer system of claim 13, wherein the JVMF formatted message is a JVMF K04.13 message.

15. The computer system of claim 13, wherein the METAR formatted message comprises a plurality of METAR data fields and the JVMF formatted message comprises a plurality of JVMF data fields, the central processing unit being further operable to, in the event that one particular METAR data field does not include a corresponding JVMF data field of the same type, store the one particular METAR data field in a comment JVMF data field of the JVMF formatted message.

16. The computer system of claim 15, wherein the one particular METAR data field is a visibility METAR data field.

17. The computer system of claim 13, wherein the METAR formatted message has an ICAO station identifier METAR data field and the JVMF formatted message has a latitude JVMF data field and a longitude JVMF data field, the central processing unit being further operable to convert the ICAO station identifier METAR data field to a latitude and longitude coordinates for placement in the latitude and longitude JVMF data fields respectively.

18. The computer system of claim 17, wherein the central processing unit is operable to convert the ICAO station identifier METAR data field to the latitude and longitude coordinates via a lookup table.

19. The computer system of claim 13, wherein the METAR formatted message has an ICAO station identifier METAR data field, the central processing unit being operable to place the ICAO station identifier in a comments field of the JVMF formatted message.

20. The computer system of claim 13, wherein the METAR formatted message has a particular METAR data field and the JVMF formatted message has a corresponding JVMF data field, in the event that the particular METAR data field is temporarily unavailable, the central processing unit being further operable to place an illegal value in the corresponding JVMF data field.

21. The computer system of claim 20, wherein the particular METAR data field is an barometric pressure METAR data field.

22. The computer system of claim 13, wherein the JVMF formatted message comprises a comments JVMF data field, the comments JVMF data field comprises a plurality of message fields, at least one of the plurality of message fields being a plain English station name.
